(19) United States
(12) Patent Application Publication
(10) Pub. No.: US 2023/0299271 A1
(43) Pub. Date: Sep. 21, 2023

(54) CARBON-COATED SILICON PARTICLES FOR LITHIUM BATTERIES

(71) Applicant: Wacker Chemie AG, Munich (DE)

(72) Inventors: Stefan HAUFE, Neubiberg (DE); Christoph DRAEGER, Munich (DE); Jennifer WEGENER, Munich (DE)

(73) Assignee: Wacker Chemie AG, Munich (DE)

(21) Appl. No.: 18/013,798

(22) PCT Filed: Jul. 2, 2020
(86) PCT No.: PCT/EP2020/068651

§ 371 Date: Dec. 29, 2022

(51) Int. Cl. H01M 4/36; H01M 4/587; H01M 4/38; C01B 33/02

(52) U.S. Cl. CPC H01M 4/366; H01M 4/587; H01M 4/386; C01B 33/02; C01P 2004/80; C01P 2006/40; C01P 2004/61

(57) ABSTRACT

Non-aggregated carbon-coated silicon particles are prepared, which have average particle diameters d₅₀ of 1 to 15 μm and contain ≤10 wt. % carbon and ≥90 wt. % silicon relative to the total weight of the carbon-coated silicon particles, by treating dry mixtures containing silicon particles and one or more polymeric carbon precursors, which contain one or more oxygen atoms and one or more heteroatoms selected from the group consisting of nitrogen, sulfur and phosphorus, in oxidative atmosphere at a temperature of 200 to 400° C. (thermal treatment) and subsequently performing carbonization in inert atmosphere.

### CROSS REFERENCE TO RELATED APPLICATIONS

This application is the U.S. National Phase of PCT Application No. PCT/EP2020/068651 filed Jul. 2, 2020, and published as WO2022/002404 the disclosure of which is incorporated in its entirety by reference herein.

### BACKGROUND OF THE INVENTION

### 1. Field of the Invention

This disclosure relates to processes for producing carbon-coated silicon particles, to carbon-coated silicon particles obtainable in this way, and to processes for producing lithium-ion batteries.

### 2. Description of the Related Art

Of the electrochemical energy storage means commercially available, rechargeable lithium-ion batteries currently have the highest specific energy, of up to 250 Wh/kg. They are utilized in particular in the field of portable electronics, for tools and also for means of transport, for example two-wheeled vehicles or automobiles. For use in automobiles in particular, it is however necessary to significantly increase the energy density of the batteries in order to achieve longer vehicle ranges. The negative electrode material (“anode”) used in practice is currently mainly graphitic carbon. A disadvantage is however its relatively low electrochemical capacity of theoretically 372 mAh/g, which corresponds to only about one tenth of the electrochemical capacity theoretically achievable with lithium metal. The highest known storage capacity for lithium ions is that of silicon, at 4199 mAh/g.

Disadvantageously, silicon-containing electrode active materials undergo extreme volume changes of up to about 300% when charging or discharging with lithium, which leads to severe mechanical stressing of the active material and of the entire electrode structure; this is also referred to as electrochemical grinding and leads to a loss of electrical contacting and hence to destruction of the electrode with loss of capacity. A further problem is that the surface of the silicon anode material reacts with constituents of the electrolyte to form passivating protective layers (solid electrolyte interphase; SEI), which leads to an irreversible loss of mobile lithium and thus to a loss of capacity.

In order to counteract such problems, a number of works have recommended carbon-coated silicon particles as active material for anodes of lithium-ion batteries. For instance, Liu, Journal of The Electrochemical Society, 2005, 152 (9), pages A1719 to A1725, describes carbon-coated silicon particles having a carbon content of 27% by weight. Silicon particles coated with 20% by weight of carbon are described by Ogumi in the Journal of The Electrochemical Society, 2002, 149 (12), pages A1598 to A1603. JP2002151066 reports a carbon content of 11% to 70% by weight for carbon-coated silicon particles. The coated particles of Yoshio, Chemistry Letters, 2001, pages 1186 to 1187, contain 20% by weight of carbon and have an average particle size of 18 μm. The layer thickness of the carbon coating is 1.25 μm. The publication by N.-L. Wu, Electrochemical and Solid-State Letters, 8 (2), 2005, pages A100 to A103, discloses carbon-coated silicon particles having a carbon content of 27% by weight.

JP2004-259475 teaches processes of coating silicon particles with non-graphite carbon material and optionally graphite followed by carbonizing, the process cycle of coating and carbonizing being repeated multiple times. In addition, JP2004-259475 teaches using the non-graphite carbon material and any graphite in the form of a suspension for the surface coating. Such process measures lead, as is known, to aggregated carbon-coated silicon particles. In U.S. Pat. No. 8,394,532 too, carbon-coated silicon particles were produced from a dispersion. A carbon fiber content of 20% by weight based on silicon is specified for the starting material.

EP1024544 is concerned with silicon particles, the surface of which is fully covered with a carbon layer. However, only aggregated carbon-coated silicon particles are specifically disclosed, as shown by the examples based on average particle diameters of silicon and of the products. EP2919298 teaches processes for producing composites by pyrolyzing mixtures comprising silicon particles and mostly polymers and then grinding, which implies aggregated particles. US2016/0104882 relates to composite materials in which a multitude of silicon particles are embedded in a carbon matrix. The individual carbon-coated silicon particles are thus present in the form of aggregates. WO2018/229515 describes processes for producing composite particles in which silicon particles having average particle diameters d₅₀ of 20 to 500 nm and carbon precursors containing nitrogen or oxygen atoms are dispersed in a solvent and then dried, optionally first thermally treated at 200 to 400° C., and finally pyrolyzed to form Si/C composite particles having diameters of 1 to 25 μm.

US2009/0208844 describes silicon particles having a carbon coating containing electrically conductive elastic carbon material, specifically expanded graphite. This discloses silicon particles on the surface of which are attached expanded graphite particles in particulate form by means of a carbon coating. No process-related pointers regarding the production of nonaggregated carbon-coated silicon particles can be inferred from US2009/0208844. US2012/0100438 includes porous silicon particles with carbon coating, but without specific details relating to the production of the coating and the carbon and silicon contents of the particles.

WO2018/082880 teaches dry processes for coating silicon particles with carbon in which mixtures of silicon particles and fusible carbon precursors are heated to a temperature of below 400° C. until the carbon precursors have completely melted and then carbonized; or alternatively CVD (chemical vapor deposition) processes. Specifically mentioned carbon precursors for the dry process are saccharides, polyaniline, polystyrene, polyacrylonitrile, and pitch. Both the melting and the carbonization are specifically carried out under anaerobic conditions. PCT/EP2020/057362 (application number) describes the coating of silicon particles with carbon using polyacrylonitrile as carbon precursor.

In EP1054462, anodes are produced by coating current collectors with silicon particles and binders and then carbonizing them.

Against this background, there was in addition the object of modifying silicon particles as active material for anodes of lithium-ion batteries in such a way that the corresponding lithium-ion batteries have high initial reversible capacities and also stable electrochemical behavior with the lowest possible drop in reversible capacity (fading) in subsequent cycles.

### SUMMARY OF THE INVENTION

Nonaggregated carbon-coated silicon particles are produced by a method which includes thermal treatment and carbonization of a dry mixture. The dry mixture includes silicon particles and one or more polymeric carbon precursors. The polymer carbon precursors may include one or more functional groups selected from the group consisting of amides, lactams, imides, carbamates, urethanes, sulfates, sulfate esters, sulfites, sulfite esters, sulfonic acids, sulfonic esters, thioesters, phosphoric acid, phosphoric esters, phosphoric acid amides, phosphonic acid, phosphonic esters, and phosphonic acid amides. The thermal treatment may include an oxidative atmosphere at a temperature of 200 to 400° C. The resulting nonaggregated carbon-coated silicon particles may have an average volume weighted particle diameter d₅₀ of 1 to 15 μm, which may be determined by static laser scattering using the Mie model with a Horiba LA 950 instrument and with ethanol as a dispersion medium. The nonaggreated carbon-coated silicon particles may include ≤10% by weight of carbon and ≥90% by weight of silicon based on the total weight of the nonaggregated carbon-coated silicon particles.

### BRIEF DESCRIPTION OF THE DRAWINGS

FIG. 1 is an SEM image of a silicon particles.

FIG. 2 is an SEM image of a nonaggregated carbon-coated silicon particles obtained according to this disclosure.

### DETAILED DESCRIPTION OF THE PREFERRED EMBODIMENTS

The invention provides processes for producing nonaggregated carbon-coated silicon particles, having average particle diameters d₅₀ of 1 to 15 μm and containing ≤10% by weight of carbon and ≥90% by weight of silicon, in each case based on the total weight of the carbon-coated silicon particles, by treating dry mixtures comprising silicon particles and one or more polymeric carbon precursors containing one or more oxygen atoms and one or more heteroatoms selected from the group consisting of nitrogen, sulfur, and phosphorus in an oxidative atmosphere at a temperature of 200 to 400° C. (thermal treatment) and then carbonizing this in an inert atmosphere.

The invention further provides nonaggregated carbon-coated silicon particles having average particle diameters d₅₀ of 1 to 15 μm and containing ≤10% by weight of carbon and ≥90% by weight of silicon, in each case based on the total weight of the carbon-coated silicon particles, obtainable by the process according to the invention.

The nonaggregated carbon-coated silicon particles according to the invention are hereinafter also referred to as carbon-coated silicon particles for short.

In order to be able to obtain the carbon-coated silicon particles of the invention, it was found that the dry mixtures according to the invention are subjected to the treatment according to the invention.

Surprisingly, carbon-coated silicon particles that are not aggregated are obtainable in accordance with the invention. Sticking or sintering and hence aggregation of different particles surprisingly occurred only to an insignificant degree or not at all. This was all the more surprising since the polymeric carbon precursors are usually present in liquid or paste form during the carbonization and can act as an adhesive, which leads to the particles caking together after cooling or carbonization and thus to aggregated products. Surprisingly, nonaggregated carbon-coated silicon particles were nevertheless obtained in accordance with the invention.

The carbon-coated silicon particles are preferably present in the form of isolated particles or loose agglomerates, but not in the form of aggregates of carbon-coated silicon particles. Agglomerates are clusters of multiple carbon-coated silicon particles. Aggregates are assemblies of carbon-coated silicon particles. Agglomerates can be separated into the individual carbon-coated silicon particles, for example by kneading or dispersing processes. Aggregates cannot be separated into the individual particles in this way without destroying carbon-coated silicon particles. However, in individual cases this does not preclude the formation of aggregated carbon-coated silicon particles in small amounts in the process according to the invention.

The presence of carbon-coated silicon particles in the form of aggregates can be visualized for example by scanning electron microscopy (SEM) or transmission electron microscopy (TEM). Particularly suitable for this purpose is a comparison of SEM images or TEM images of the uncoated silicon particles with corresponding images of the carbon-coated silicon particles. Static light scattering methods for determining particle size distributions or particle diameters are not on their own suitable for establishing the presence of aggregates. However, if the carbon-coated silicon particles have particle diameters that within the limits of the measurement accuracy are significantly larger than those of the silicon particles used to produce them, this points to the presence of aggregated carbon-coated silicon particles. Particular preference is given to using the abovementioned methods of determination in combination.

The carbon-coated silicon particles have a degree of aggregation of preferably ≤40%, more preferably ≤30%, and most preferably ≤20%. The degree of aggregation is determined by sieve analysis. The degree of aggregation generally corresponds to the percentage of the particles that after dispersion in ethanol with simultaneous sonication do not pass through a sieve having a mesh size of twice the d₉₀ value of the volume-weighted particle size distribution of the respective particle composition undergoing analysis and in particular do not pass through a sieve having a mesh size of 20 μm.

The difference between the volume-weighted particle size distributions d₅₀ of the carbon-coated silicon particles and of the silicon particles used as starting material is also an indicator that the carbon-coated silicon particles are nonaggregated. The difference between the volume-weighted particle size distribution d₅₀ of the carbon-coated silicon particles and the volume-weighted particle size distribution d₅₀ of the silicon particles used as starting material for producing the carbon-coated silicon particles is preferably ≤5 μm, more preferably ≤3 μm and most preferably ≤2 μm.

A consequence of the use according to the invention of the carbon precursors according to the invention and of the oxidative atmosphere during the thermal treatment is that the carbon-coated silicon particles according to the invention differ structurally from conventional carbon-coated silicon particles. This is also manifested for example in the enhanced cycling stability observed in lithium-ion batteries when the carbon-coated silicon particles according to the invention are used as anode active material, which can be explained only by the anode active material having particular structural properties. Without being bound to a particular theory, these effects can be brought about by specific contents of oxygen atoms or heteroatoms or specific oxygen- or heteroatom-containing functional groups or species in the carbon-coated silicon particles that originate from the carbon precursors of the invention or from the oxidative atmosphere in the thermal treatment according to the invention of the dry mixtures. Such oxygen atoms or heteroatoms can for example improve the cohesion within the carbon coating or the adhesion of the carbon coating on the silicon particles or increase their elasticity, for example via van der Waals interactions, hydrogen bonds, ionic interactions or especially covalent bonds.

The carbon-coated silicon particles have volume-weighted particle size distributions having diameter percentiles d₅₀ of preferably ≥2 μm, more preferably ≥3 μm, and most preferably ≥4 μm. The carbon-coated silicon particles have d₅₀ values of preferably ≤10 μm, more preferably ≤8 μm, and most preferably ≤6 μm.

The carbon-coated silicon particles have volume-weighted particle size distributions having d₉₀ values of preferably ≤40 μm, more preferably d₉₀≤30 μm, and even more preferably d₉₀≤10 μm.

The carbon-coated silicon particles have volume-weighted particle size distributions having d₉₀ values of preferably ≥0.5 μm, more preferably d₉₀≥1 μm, and most preferably d₉₀≥1.5 μm.

The particle size distribution of the carbon-coated silicon particles may be bimodal or polymodal and is preferably monomodal, and also preferably narrow. The volume-weighted particle size distribution of the carbon-coated silicon particles has a width (d₉₀−d₁₀)/d₅₀ of preferably 3, more preferably 2.5, particularly preferably 2, and most preferably 1.5.

The volume-weighted particle size distribution of the carbon-coated silicon particles was determined by static laser scattering using the Mie model with a Horiba LA 950 instrument and with ethanol as dispersion medium for the carbon-coated silicon particles.

The carbon coating of the carbon-coated silicon particles has an average layer thickness within a range from preferably 1 to 100 nm, more preferably 1 to 50 nm (method of determination: scanning electron microscopy (SEM) and/or transmission electron microscopy (TEM)).

The carbon-coated silicon particles typically have BET surface areas of preferably 0.1 to 10 m²/g, more preferably 0.3 to 8 m²/g, and most preferably 0.5 to 5 m²/g (determination in accordance with DIN ISO 9277:2003-05 with nitrogen).

The carbon coating may be porous and is preferably nonporous. The carbon coating has a porosity of preferably ≤2% and more preferably ≤1% (method for determining total porosity: 1 minus [ratio of apparent density (determined by xylene pycnometry in accordance with DIN 51901) and skeletal density (determined by He pycnometry in accordance with DIN 66137-2)]).

The carbon coating of the carbon-coated silicon particles is preferably impermeable to liquid media such as aqueous or organic solvents or solutions, especially aqueous or organic electrolytes, acids or alkalis.

In the carbon-coated silicon particles, the silicon particles are partially or preferably fully embedded in carbon. The surface of the carbon-coated silicon particles consists partially or preferably entirely of carbon.

In general, the silicon particles are not located in pores. The carbon coating is generally in direct contact with the surface of the silicon particles.

The carbon coating is generally in the form of a film and is generally not particulate or fibrous. In general, the carbon coating does not contain any particles or any fibers, such as carbon fibers or graphite particles.

In general, each carbon-coated silicon particle contains one silicon particle (method of determination: scanning electron microscopy (SEM) and/or transmission electron microscopy (TEM)).

The carbon of the carbon coating is generally obtained by carbonization according to the invention. The carbon of the carbon coating may be present for example in amorphous form or preferably partially or completely in crystalline form.

The carbon-coated silicon particles may assume any desired shapes and are preferably splintery.

The carbon-coated silicon particles preferably contain 0.1% to 8% by weight, more preferably 0.3% to 6% by weight, even more preferably 0.5% to 4% by weight, and particularly preferably 0.5% to 3% by weight, of carbon. The carbon-coated silicon particles preferably contain 92% to 99.9% by weight, more preferably 94% to 99.7% by weight, even more preferably 96% to 99.5% by weight, and particularly preferably 97% to 99.5% by weight, of silicon particles. The above percentages by weight are in each case based on the total weight of the carbon-coated silicon particles.

The carbon coating may have oxygen contents of for example ≤20% by weight, preferably ≤10% by weight, and more preferably ≤5% by weight. Nitrogen may be present in the carbon coating for example to an extent of 0% to 10% by weight and preferably between 0.05% and 5% by weight. When present, nitrogen is preferably chemically bonded in the form of heterocycles, for example as pyridine or pyrrole units (N), or is bonded to carbon species as a functional group containing a nitrogen atom, for example amino groups. In addition to the principal constituents mentioned, it is also possible for further chemical elements to be present, for example in the form of an intentional addition or coincidental impurity: such as Li, Fe, Al, Cu, Ca, K, Na, S, Cl, Zr, Ti, Pt, Ni, Cr, Sn, Mg, Ag, Co, Zn, B, P, Sb, Pb, Ge, Bi or rare earth elements; the contents thereof are preferably ≤1% by weight and more preferably ≤100 ppm. The above percentages by weight are in each case based on the total weight of the carbon coating.

In addition, the carbon-coated silicon particles may contain one or more conductive additives, for example graphite, conductive black, graphene, graphene oxide, graphene nanoplatelets, carbon nanotubes or metallic particles such as copper. Preferably, no conductive additives are present.

The silicon particles have volume-weighted particle size distributions having diameter percentiles d₅₀ of preferably 1 to less than 15 μm, more preferably 2 to less than 10 μm, and most preferably 3 to less than 8 μm (determination: with a Horiba LA 950 instrument as described above for the carbon-coated silicon particles).

The silicon particles are preferably nonaggregated and more preferably nonagglomerated. Aggregated means that spherical or very largely spherical primary particles, such as those initially formed in gas-phase processes during the production of the silicon particles, combine to form aggregates in the further course of the reaction in the gas-phase process. Aggregates or primary particles can also form agglomerates. Agglomerates are a loose cluster of aggregates or primary particles. Agglomerates can easily be split up again into aggregates by the kneading and dispersion processes that are typically employed. Aggregates can be broken down into the primary particles only partially by such processes, if at all. Because of the way they are formed, aggregates and agglomerates inevitably have entirely different grain shapes than the preferred silicon particles. In the determination of aggregation, what has been said in relation to the carbon-coated silicon particles applies by analogy to the silicon particles.

The silicon particles preferably have splintery particle shapes.

Silicon particles can consist of elemental silicon, a silicon oxide, or a binary, ternary or multinary silicon/metal alloy (for example with Li, Na, K, Sn, Ca, Co, Ni, Cu, Cr, Ti, Al, Fe). Elemental silicon is preferred, particularly since it has an advantageously high storage capacity for lithium ions.

Elemental silicon is generally understood to mean high-purity polysilicon having a low content of foreign atoms (for example B, P, As), silicon intentionally doped with foreign atoms (for example B, P, As), but also silicon from metallurgical processing that may include elemental impurities (for example Fe, Al, Ca, Cu, Zr, C).

If the silicon particles contain a silicon oxide, the stoichiometry of the oxide SiOₓ is preferably in the range 0<x<1.3. If the silicon particles contain a silicon oxide having higher stoichiometry, this is preferably located at the surface of the silicon particles, preferably with a layer thickness of less than 10 nm.

When the silicon particles have been alloyed with an alkali metal M, the stoichiometry of the alloy M_{y}Si is preferably in the range 0<y<5. The silicon particles may optionally have been prelithiated. If the silicon particles have been alloyed with lithium, the stoichiometry of the alloy Li_{z}Si is preferably in the range 0<z<2.2.

Particular preference is given to silicon particles containing ≥80 mol % of silicon and/or ≤20 mol % of foreign atoms, very particularly preferably ≤10 mol % of foreign atoms.

In a preferred embodiment, the silicon particles consist to an extent of preferably ≥96% by weight, more preferably ≥98% by weight, of silicon, based on the total weight of the silicon particles. The silicon particles preferably contain essentially no carbon.

The surface of the silicon particles may optionally be covered by an oxide layer or by other inorganic and organic groups. Particularly preferred silicon particles bear on the surface Si—OH— or Si—H— groups or covalently attached organic groups, for example alcohols or alkenes.

Preference is given to polycrystalline silicon particles. Polycrystalline silicon particles have crystallite sizes of preferably ≤200 nm, more preferably ≤100 nm, even more preferably ≤60 nm, particularly preferably ≤20 nm, most preferably ≤18 nm, and most preferably of all ≤16 nm. The crystallite size is preferably ≥3 nm, more preferably ≥6 nm and most preferably ≥9 nm. The crystallite size is determined by X-ray diffraction pattern analysis according to the Scherrer method from the full width at half maximum of the Si (111) diffraction peak at 2θ=28.4°. The standard used for the X-ray diffraction pattern of silicon is preferably the NIST X-ray diffraction standard reference material SRM640C (single-crystal silicon).

The silicon particles may be produced for example by grinding processes, for example wet grinding or preferably dry grinding processes. Preference is given here to using jet mills, for example counter-jet mills, or impact mills, planetary ball mills or stirred ball mills. Wet grinding generally takes place in a suspension with organic or inorganic dispersion media. This may involve the use of established processes, such as those described in the patent application having application number DE 102015215415.

The process of the invention for producing the carbon-coated silicon particles employs dry mixtures comprising silicon particles and carbon precursors of the invention.

The dry mixtures contain the silicon particles to an extent of preferably 20% to 99% by weight, more preferably 30% to 98% by weight, even more preferably 50% to 97% by weight, particularly preferably 70% to 96% by weight, and most preferably 80% to 95% by weight, based on the total weight of the dry mixtures.

Preferably, the polymeric carbon precursors contain oxygen and nitrogen atoms and optionally sulfur and/or phosphorus atoms. More preferably, the polymeric carbon precursors contain oxygen and nitrogen atoms and no other heteroatoms.

The polymeric carbon precursors may bear for example one or more functional groups selected from the group comprising amides, lactams, imides, carbamates, urethanes, sulfates, sulfate esters, sulfites, sulfite esters, sulfonic acids, sulfonic esters, thioesters, phosphoric acid, phosphoric esters, phosphoric acid amides, phosphonic acid, phosphonic esters, and phosphonic acid amides. The abovementioned acids may also be present in the form of their salts, for example alkali metal, alkaline earth metal or ammonium salts. Most preferred functional groups are amides and lactams.

The polymeric carbon precursors may be aliphatic, preferably aromatic, and more preferably heteroaromatic.

Preferred polymeric carbon precursors are polyvinyl lactams, polyamides, polyimides, polyurethanes, polypeptides, and proteins. Particular preference is given to polyvinyl lactams. Polyvinyl lactams are preferably polymers of N-vinylated nitrogen heterocycles bearing one or more carbonyl groups, for example β-, γ-, δ- or ε-lactams vinylated on the nitrogen atom, especially vinylpyrrolidone. Most preferred is polyvinylpyrrolidone.

The polymeric carbon precursors have molecular weights Mw of preferably 200 to 2,000,000 g/mol, more preferably 500 to 1,500,000 g/mol, even more preferably 1000 to 500,000 g/mol, particularly preferably 1500 to 100,000 g/mol, and most preferably 2000 to 50,000 g/mol (method of determination: GPC).

The dry mixtures contain the polymeric carbon precursors to an extent of preferably 1% to 80% by weight, more preferably 2% to 70% by weight, even more preferably 3% to 50% by weight, particularly preferably 4% to 30% by weight, and most preferably 5% to 20% by weight, based on the total weight of the dry mixtures.

The dry mixtures may optionally also comprise one or more further carbon precursors different from the polymeric carbon precursors according to the invention. The dry mixtures contain preferably ≥60% by weight, more preferably ≥80% by weight, and particularly preferably ≥90% by weight, of polymeric carbon precursors according to the invention, based on the total weight of the entirety of the carbon precursors used. Most preferably, the dry mixtures contain no further carbon precursors besides the polymeric carbon precursors according to the invention. Examples of further carbon precursors are polyacrylonitrile; carbohydrates such as mono-, di-, and polysaccharides; polyvinylaromatics or polyaromatics such as polyaniline, polystyrene; polyaromatic hydrocarbons such as pitches or tars; or gaseous hydrocarbons, such as are commonly used in alternative CVD (chemical vapor deposition) processes.

In addition, the dry mixtures may contain one or more conductive additives, for example graphite, conductive carbon black, graphene, graphene oxide, graphene nanoplatelets, carbon nanotubes or metallic particles such as copper. Preferably, no conductive additives are present.

In general, no solvent is used in the process according to the invention. The process is generally carried out in the absence of solvent. However, this does not rule out the possibility that the starting materials used may have residual contents of solvent, for example as a consequence of their production. The dry mixtures, more particularly the silicon particles and/or the polymeric carbon precursors, contain preferably ≤2% by weight, more preferably ≤1% by weight, and most preferably ≤0.5% by weight, of solvent. Examples of solvents include inorganic solvents, such as water, or organic solvents, especially hydrocarbons, ethers, esters, nitrogen-functional solvents, sulfur-functional solvents, alcohols such as ethanol and propanol, benzene, toluene, dimethylformamide, N-methyl-2-pyrrolidone, N-ethyl-2-pyrrolidone, and dimethyl sulfoxide.

The silicon particles and the polymeric carbon precursors may be mixed in a conventional manner, for example at temperatures of 0 to 50° C., preferably 15 to 35° C. Mixing is preferably carried out in an oxidative atmosphere, especially in the presence of air. It is possible to use standard mixers, such as pneumatic mixers, free-fall mixers, such as container mixers, cone mixers, rolling drum mixers, drum hoop mixers, tumble mixers, or displacement and impeller mixers such as drum mixers and screw mixers. Preference is given to using mills for mixing, such as drum mills or ball mills, especially planetary ball mills or stirred ball mills.

The thermal treatment takes place in an oxidative atmosphere. As oxidative gases, an oxidative atmosphere may comprise for example carbon dioxide, nitrogen oxides, sulfur dioxide, ozone, peroxides, and especially oxygen or water vapor. The oxidative atmosphere contains oxidative gases to an extent of preferably 1% to 100% by volume, more preferably 5% to 80% by volume, even more preferably 10% to 50% by volume, and particularly preferably 15% to 30% by volume. In an alternative embodiment, the oxidative atmosphere contains oxidative gases to an extent of preferably 1% to 25% by volume, more preferably 2% to 20% by volume, and particularly preferably 5% to 15% by volume. The oxidative atmosphere may also comprise inert gases such as nitrogen, noble gases or other inert gases. The content of inert gases is preferably ≤99% by volume, more preferably 20% to 95% by volume, particularly preferably 50% to 90% by volume, and most preferably 70% to 85% by volume. The oxidative atmosphere may also comprise impurities or other gaseous components, preferably to an extent of ≤10% by volume, more preferably ≤5% by volume, and most preferably ≤1% by volume. The stated percentages by volume are in each case based on the total volume of the oxidative atmosphere. Most preferably, the oxidative atmosphere comprises air, such as ambient air or synthetic air. Most preferably of all, the oxidative atmosphere consists of air.

The oxidative atmosphere has a pressure of preferably 0.1 to 10 bar, more preferably 0.5 to bar, and most preferably 0.7 to 1.5 bar. The oxidative atmosphere comprises oxidative gases having a partial pressure of preferably 0.1 to 2000 mbar, more preferably 1 to 1000 mbar, particularly preferably 10 to 700 mbar, and most preferably 100 to 500 mbar.

The temperatures in the thermal treatment are preferably ≤350° C., more preferably ≤300° C., and most preferably ≤280° C. The temperatures are preferably ≥210° C., more preferably ≥230° C., and most preferably ≥250° C.

The temperatures in the thermal treatment are preferably 50 to 300° C., more preferably 100 to 250° C., particularly preferably 125 to 200° C., and most preferably 150 to 160° C., below the decomposition temperature of the respective polymeric carbon precursor. The decomposition temperatures of the polymeric carbon precursors can for example be determined in a conventional manner by TGA (thermogravimetric analysis; measurement in a nitrogen atmosphere with a heating rate of 10° C./min; the decomposition temperature is derived from the inflection point of the resulting measurement curve).

The temperature in the thermal treatment is preferably between the possible melting temperature and the decomposition temperature of the respective polymeric carbon precursor. Preferably, the polymeric carbon precursors are present during the thermal treatment partially or completely in the form of a melt.

The thermal treatment lasts for preferably 10 minutes to 24 hours, preferably 30 minutes to 10 hours, and more preferably 1 to 4 hours. The duration of the thermal treatment is based for example on the temperature selected in the individual case or on the respective polymeric carbon precursor.

The dry mixtures can be heated by increasing the temperature intermittently or preferably continuously. For intermittent heating, the dry mixtures can be introduced for example into a preheated furnace. In the case of continuous heating, the mixtures may be heated at a constant or variable heating rate, but generally at a positive heating rate. The heating rate refers to the rise in temperature per unit time. The heating rates until the temperature is reached or during the thermal treatment are preferably 1 to 20° C. per minute, more preferably 1 to 15° C./min, particularly preferably 1 to 10° C./min, and most preferably 1 to 5° C./min. It is preferable for there to be one or more hold stages at specific temperatures, especially in the range of the abovementioned temperatures in the thermal treatment.

The temperatures, the oxidative atmosphere, and the pressure in the thermal treatment and also the molecular weight Mw of the polymeric carbon precursors, are preferably chosen such that under the conditions of the thermal treatment the respective polymeric carbon precursors do not combust or at most partially combust, do not decompose or at most partially decompose, and do not carbonize or at most partially carbonize. The combustion temperature, the decomposition temperature or the carbonization temperature of the polymeric carbon precursors can be rapidly determined in a conventional manner, for example by DSC (differential scanning calorimetry) or thermogravimetric analysis (TGA).

In general, carbonization of the polymeric carbon precursors does not occur during the thermal treatment or occurs only to an insignificant degree. The proportion of the polymeric carbon precursors that undergo carbonization during the thermal treatment is preferably ≤20% by weight, more preferably ≤10% by weight, and most preferably ≤5% by weight, based on the total weight of the entirety of the polymeric carbon precursors used.

The thermal treatment of the polymeric carbon precursors may take place in conventional furnaces, for example in tube furnaces, calcination furnaces, rotary kilns, belt furnaces, chamber furnaces, retort furnaces or fluidized-bed reactors. The heating may take place by convection or induction, by means of microwaves or plasma.

In one embodiment, the thermal treatment is followed by cooling, for example to a temperature within a range from 10 to 30° C., especially ambient temperature. Cooling can be carried out actively or passively, evenly or in a stepwise manner. The product thus obtained can be stored and/or—after replacing the oxidative atmosphere with an inert atmosphere—supplied to the carbonization.

Alternatively, it is also possible for the oxidative atmosphere to be replaced with an inert atmosphere, and the carbonization then carried out, immediately after the thermal treatment without cooling, especially without cooling to room temperature, preferably at the temperatures in the thermal treatment.

In the course of the carbonization, the polymeric carbon precursors are generally converted into inorganic carbon.

The inert atmosphere is preferably an atmosphere of nitrogen or noble gas, especially an argon atmosphere. The inert atmosphere contains preferably ≥95% by volume, more preferably ≥99% by volume, and most preferably ≥99.9% by volume, of nitrogen or noble gases. The inert atmosphere contains preferably ≤5% by volume, more preferably ≤1% by volume, and most preferably ≤0.1% by volume, of oxidative gases, especially oxygen. The inert gas atmosphere may optionally additionally contain proportions of a reducing gas such as hydrogen. The inert gas atmosphere may be a static atmosphere above the reaction medium or it may flow over the reaction mixture in the form of a gas stream.

The carbonization takes place at temperatures of preferably above 400 to 1400° C., more preferably 700 to 1200° C., and most preferably 900 to 1100° C. The mixtures are preferably held at the abovementioned temperatures for 30 minutes to 24 hours, more preferably 1 to 10 hours, and most preferably 2 to 4 hours.

The mixtures can be heated by increasing the temperature intermittently or preferably continuously. The heating rates until the carbonization temperatures are reached are preferably 1 to 20° C. per minute, more preferably 2 to 15° C./min, and most preferably 3 to 10° C./min. A stepwise process with various intermediate temperatures and heating rates is also possible. Once the target temperature has been reached, the reaction mixture is normally kept at that temperature for a certain time or is then immediately cooled. Cooling can be carried out actively or passively, evenly or in a stepwise manner. The carbonization preferably takes place in the same devices, in particular in the same devices that are also used for the thermal treatment.

The thermal treatment and/or the carbonization may be carried out with continuous mixing of the reaction mixture or preferably statically, i.e. without mixing. The components present in solid form are preferably not fluidized. This reduces the technical complexity.

The carbon-coated silicon particles obtained by the process according to the invention may be supplied directly to the further utilization thereof, for example for production of electrode materials, or alternatively may be freed of oversized or undersized particles by classification techniques (sieving, sifting). It is preferable for there to be no mechanical aftertreatments or classification, especially no grinding.

The carbon-coated silicon particles are suitable for example as silicon-based active materials for anode active materials for lithium-ion batteries.

The invention further provides processes for producing lithium-ion batteries by using the carbon-coated silicon particles obtained by the process according to the invention as anode active material in the production of anodes for lithium-ion batteries. Lithium-ion batteries generally comprise a cathode, an anode, a separator, and an electrolyte.

It is preferable that the cathode, the anode, the separator, the electrolyte and/or another reservoir located in the battery housing comprises one or more inorganic salts selected from the group comprising nitrate (NO₃⁻), nitrite (NO₂⁻), azide (N₃⁻), phosphate (PO₄³⁻), carbonate (CO₃²⁻), borate and fluoride (F⁻) salts of alkali metals, alkaline earth metals and ammonium. It is particularly preferable that inorganic salts are present in the electrolyte and/or especially in the anode. Particularly preferred inorganic salts are nitrate (NO₃⁻), nitrite (NO₂⁻), and azide (N₃⁻) salts of alkali metals, alkaline earth metals and ammonium, most preferred are lithium nitrate and lithium nitrite. Further, especially additional, inorganic salts may also be present, for example LiBOB or LiPF₆.

The concentration of the inorganic salts in the electrolyte is preferably 0.01 to 2 molar, more preferably 0.01 to 1 molar, even more preferably 0.02 to 0.5 molar, and most preferably 0.03 to 0.3 molar. The loading of the inorganic salts in the anode, in the cathode and/or in the separator, especially in the anode, is preferably 0.01 to 5.0 mg/cm², more preferably 0.02 to 2.0 mg/cm², and most preferably 0.1 to 1.5 mg/cm², in each case based on the surface area of the anode, of the cathode and/or of the separator.

The anode, the cathode or the separator preferably contains 0.8% to 60% by weight, more preferably 1% to 40% by weight, and most preferably 4% to 20% by weight, of inorganic salts. In the case of the anode, these percentages relate to the dry weight of the anode coating, in the case of the cathode they relate to the dry weight of the cathode coating, and in the case of the separator they relate to the dry weight of the separator.

The anode material of the fully charged lithium-ion battery is preferably only partially lithiated. It is thus preferable for the anode material, more particularly the carbon-coated silicon particles of the invention, to be only partially lithiated in the fully charged lithium-ion battery. “Fully charged” refers to the battery state in which the anode material of the battery has its highest loading of lithium. Partial lithiation of the anode material means that the maximum lithium absorption capacity of the silicon particles in the anode material is not exhausted. The maximum lithium absorption capacity of the silicon particles corresponds generally to the formula Li_{4.4}Si and is thus 4.4 lithium atoms per silicon atom. This corresponds to a maximum specific capacity of 4200 mAh per gram of silicon.

The ratio of the lithium atoms to the silicon atoms in the anode of a lithium-ion battery (Li/Si ratio) can be adjusted for example via the flow of electric charge. The degree of lithiation of the anode material or of the silicon particles present in the anode material is proportional to the electric charge that has flowed. In this variant, the capacity of the anode material for lithium is not fully exhausted during charging of the lithium-ion battery. This results in partial lithiation of the anode.

In an alternative, preferred variant, the Li/Si ratio of a lithium-ion battery is adjusted by the cell balancing. In this case, the lithium-ion batteries are designed such that the lithium absorption capacity of the anode is preferably greater than the lithium release capacity of the cathode. The effect of this is that, in the fully charged battery, the lithium absorption capacity of the anode is not fully exhausted, meaning that the anode material is only partially lithiated.

In the case of the partial lithiation, the Li/Si ratio in the anode material in the fully charged state of the lithium-ion battery is preferably ≤2.2, more preferably ≤1.98, and most preferably ≤1.76. The Li/Si ratio in the anode material in the fully charged state of the lithium-ion battery is preferably ≥0.22, more preferably ≥0.44, and most preferably ≥0.66.

The capacity of the silicon in the anode material of the lithium-ion battery is preferably utilized to an extent of ≤50%, more preferably to an extent of ≤45%, and most preferably to an extent of ≤40%, based on a capacity of 4200 mAh per gram of silicon.

The degree of lithiation of silicon, or the utilization of the capacity of silicon for lithium (Si capacity utilization a), can be determined for example as described in WO17025346 on page 11, line 4 to page 12, line 25, more particularly using the formula given therein for the Si capacity utilization a and the supplementary information under the headings “Bestimmung der Delithiierungs-Kapazitat β” [Determination of the delithiation capacity β] and “Bestimmung des Si-Gewichtsanteils ω_{Si}” [Determination of the proportion by weight of Si ω_{Si}], which is hereby incorporated by reference in its entirety.

The use of the carbon-coated silicon particles produced according to the invention in lithium-ion batteries surprisingly leads to an improvement in the cycle behavior thereof. Such lithium-ion batteries have a low irreversible loss of capacity in the first charging cycle and stable electrochemical behavior with only slight fading in subsequent cycles. The carbon-coated silicon particles of the invention are thus able to achieve a low initial loss of capacity and additionally a low continuous loss of capacity of the lithium-ion batteries. Overall, the lithium-ion batteries of the invention have very good stability. This means that, even after a large number of cycles, there is little presence of fatigue phenomena, for example as a consequence of mechanical destruction of the anode material of the invention or SEI.

These effects can be further enhanced by adding inorganic salts such as lithium nitrate to the lithium-ion battery.

Since the thermal treatment and/or the carbonization can also be carried out statically, i.e. without fluidization, stirring or other constant mixing of the reaction mixture, the present process can be configured in a technically simple manner. There is no need for special equipment. All this is of great advantage, especially when scaling up the process. Moreover, the present process is easier to operate compared to CVD processes, since no carbon-containing gases such as ethylene need to be handled and thus the safety requirements are lower. All in all, the present process can be carried out inexpensively, since the reaction mixture can be obtained simply by mixing the starting materials, thus eliminating any need for solvents or other customary drying steps, such as spray drying.

Surprisingly, the carbon-coated silicon particles produced according to the invention can be used to obtain lithium-ion batteries that, besides the abovementioned advantageous cycle behavior, also have a high volumetric energy density.

Furthermore, the carbon-coated silicon particles produced according to the invention advantageously have a high electrical conductivity and a high resistance to corrosive media such as organic solvents, acids or alkalis. With the carbon-coated silicon particles according to the invention, it is also possible to reduce the cell internal resistance of lithium-ion batteries.

The carbon-coated silicon particles produced according to the invention are moreover surprisingly stable in water, especially in aqueous ink formulations for anodes of lithium-ion batteries, which means that the hydrogen evolution that occurs under such conditions with conventional silicon particles can be reduced. This makes it possible to carry out processing without the aqueous ink formulation foaming, to provide stable electrode slurries, and to produce particularly homogeneous and gas bubble-free anodes. The silicon particles used as starting material in the process according to the invention release, by contrast, relatively large amounts of hydrogen in water.

Aggregated carbon-coated silicon particles as obtained for example in the coating of silicon particles with carbon using solvents or with other noninventive processes which are unable to achieve the advantageous effects to the extent of the invention, if at all.

The examples that follow serve to further elucidate the invention.

Unless stated otherwise, the examples and comparative examples that follow were carried out in air and at ambient pressure (1013 mbar) and room temperature (23° C.). The methods and materials that follow were used.

### Carbonization:

Carbonization was effected with a 1200° C. three-zone tube furnace (TFZ 12/65/550/E301) from Carbolite GmbH using cascade control including a type N sample thermocouple. The stated temperatures refer to the internal temperature of the tube furnace at the site of the thermocouple. The starting material to be carbonized in each case was weighed into one or more combustion boats made of quartz glass (QCS GmbH) and introduced into a working tube made of quartz glass. The settings and process parameters used for the carbonizations are reported in the respective examples.

### Classification/Sieving:

The C-coated Si powders obtained after the carbonization or chemical gas-phase deposition were freed of oversize particles >20 μm by wet sieving with an AS 200 basic sieving machine (Retsch GmbH) with water on stainless steel sieves. The pulverulent product was dispersed (solids content 20%) in ethanol by sonication (Hielscher UIS250V; amplitude 80%, cycle: 0.75; duration: 30 min) and applied to the sieve tower with a sieve (20 μm). The sieving was carried out with an infinite time preselection and an amplitude of 50 to 70% with a water stream passing through. The silicon-containing suspension that exited at the bottom was filtered through 200 nm nylon membrane and the filter residue dried to constant mass in a vacuum drying oven at 100° C. and 50 to 80 mbar.

### Scanning Electron Microscopy (SEM/EDX):

The microscope analyses were carried out using a Zeiss Ultra 55 scanning electron microscope and an energy-dispersive INCA x-sight x-ray spectrometer. Before analysis, the samples underwent vapor deposition of carbon with a Baltec SCD500 sputter/carbon-coating unit to prevent charging phenomena.

### Inorganic/Elemental Analysis:

The C contents were determined using a Leco CS 230 analyzer and a Leco TCH-600 analyzer was used to determine 0 and N contents. The qualitative and quantitative determination of other elements in the carbon-coated silicon particles obtained was carried out by ICP (inductively-coupled plasma) emission spectrometry (Optima 7300 DV, from Perkin Elmer). For this, the samples were subjected to acid digestion (HF/HNO₃) in a microwave (Microwave 3000, from Anton Paar). The ICP-OES determination is guided by ISO 11885 “Water quality—Determination of selected elements by inductively-coupled plasma optical emission spectrometry (ICP-OES) (ISO 11885:2007); German version EN ISO 11885:2009”, which is used for analysis of acidic aqueous solutions (for example acidified drinking water, wastewater, and other water samples and aqua regia extracts of soils and sediments).

### Particle Size Determination:

The particle size distribution was determined in accordance with ISO 13320 by static laser scattering using a Horiba LA 950. In the preparation of the samples, particular care must be taken when dispersing the particles in the measurement solution to ensure it is not the size of agglomerates that is measured, but of the individual particles. For the C-coated Si particles analyzed here, the particles were dispersed in ethanol. Prior to measurement, the dispersion was if necessary sonicated for 4 minutes at 250 W in a Hielscher UIS250v laboratory ultrasound device with LS24d5 sonotrode.

### Determination of the Degree of Aggregation of C-Coated Si Particles:

The determination is carried out by sieve analysis. The degree of aggregation corresponds to the percentage of particles that after dispersion in ethanol and simultaneous sonication do not pass through a sieve having a mesh size twice the d90 value of the volume-weighted particle size distribution of the particle composition undergoing analysis in the particular case.

### BET Surface Area Measurement:

The specific surface area of the materials was measured via gas adsorption with nitrogen using a Sorptomatic 199090 instrument (Porotec) or SA-9603MP instrument (Horiba) by the BET method in accordance with DIN ISO 9277:2003-05.

### Si Accessibility for Liquid Media:

The accessibility of silicon in the C-coated Si particles for liquid media was determined using the following test method on materials of known silicon content (from elemental analysis): 0.5 to 0.6 g of C-coated silicon was first dispersed with 20 ml of a mixture of NaOH (4 M; H₂O) and ethanol (1:1 vol.) by means of sonication and then stirred at 40° C. for 120 min. The particles were filtered through 200 nm nylon membrane, washed to neutral pH with water, and then dried in a drying oven at 100° C./50 to 80 mbar. The silicon content after the NaOH treatment was determined and compared with the Si content prior to the test. The imperviosity corresponds to the ratio of the Si content of the sample in percent after alkali treatment and the Si content in percent of the untreated C-coated particles.

### Determination of Powder Conductivity:

The specific resistance of the C-coated samples was determined under controlled pressure (up to 60 MPa) in a Keithley 2602 System Source Meter ID 266404 measurement system consisting of a pressure chamber (die radius 6 mm) and a hydraulic unit (from Caver, USA, model 38510E-9; SN: 130306).

### Example 1 (Ex. 1)

Production of silicon particles by grinding:

The silicon powder was produced according to the prior art by grinding coarse Si grit from the production of solar silicon in a fluidized-bed jet mill (Netzsch-Condux CGS16 with 90 m³/h nitrogen at 7 bar as grinding gas).

The particle size was determined in a highly diluted suspension in ethanol.

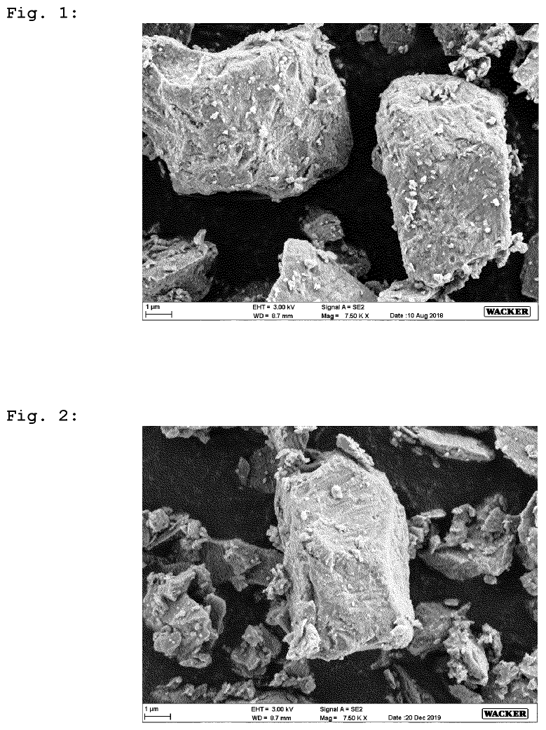

The SEM image (7500× magnification) of the silicon powder in FIG. 1 shows that the sample consists of individual, nonaggregated, splinter-shaped particles.

Elemental composition: Si ≥98% by weight; C 0.01% by weight; H<0.01% by weight; N <0.01% by weight; O 0.47% by weight.

Particle size distribution: Monomodal; D₁₀: 2.19 μm, D₅₀: 4.16 μm, D₉₀: 6.78 μm; (D₉₀−D₁₀)/D₅₀=1.10; (D₉₀−D₁₀)=4.6 μm.

Degree of aggregation: 0%.

Specific surface area (BET): 2.662 m²/g.

Si imperviosity: 0%.

Powder conductivity: 2.15 μS/cm.

### Example 2 (Ex. 2)

C-coated silicon particles produced using polyvinylpyrrolidone (PVP) as C-precursor and oxidative thermal treatment:
15.02 g of the silicon powder from example 1 (D₅₀=4.16 μm) and 2.65 g of polyvinylpyrrolidone (PVP, Mw=3600 g/mol) were mechanically mixed at 80 rpm for 3 hours using a ball-mill roller bed (Siemens/Groschopp).
17.27 g of the mixture thus obtained was placed in a quartz glass boat (QCS GmbH) and thermally treated in a three-zone tube furnace (TFZ 12/65/550/E301; Carbolite GmbH) using a cascade control system including a type N sample thermocouple in an oxidative atmosphere (air):
Heating rate 2° C./min, temperature 250° C., hold time 2 hours.

After cooling to room temperature, 16.95 g of a gray powder was obtained (yield 98%). The product obtained (16.04 g) was subjected to carbonization under argon as inert gas with the following temperature program:
Heating rate 5° C./min, temperature 1000° C., hold time 3 hours, Ar flow rate 200 ml/min.

After cooling to room temperature, 14.49 g of a black powder was obtained (carbonization yield 90%), which was freed from oversize particles by wet sieving.

14.01 g of C-coated silicon particles having a particle size of D₉₉<20 μm were obtained.

FIG. 2 shows an SEM image (7500× magnification) of the C-coated nonaggregated silicon particles obtained.

Elemental composition: Si ≥98% by weight; C 0.9% by weight; H<0.01% by weight; N 0.1% by weight; O 0.6% by weight.

Particle size distribution: Monomodal; D₁₀: 2.23 μm, D₅₀: 4.79 μm, D₉₀: 7.13 μm; (D₉₀−D₁₀)/D₅₀=1.02.

Degree of aggregation: 3.3%.

Specific surface area (BET): 2.72 m²/g.

Si imperviosity: ˜100% (impervious).

Powder conductivity: 12078.19 μS/cm.

### Comparative Example 3 (CEx. 3)

C-coated silicon particles produced using polyvinylpyrrolidone (PVP) as C-precursor, but inert thermal treatment:
15.00 g of the silicon powder from example 1 (D₅₀=4.16 μm) and 2.65 g of polyvinylpyrrolidone (PVP, Mw=3600 g/mol) were mechanically mixed at 80 rpm for 3 hours using a ball-mill roller bed (Siemens/Groschopp).
17.36 g of the mixture thus obtained was placed in a quartz glass boat (QCS GmbH) and thermally treated in a three-zone tube furnace (TFZ 12/65/550/E301; Carbolite GmbH) using a cascade control system including a type N sample thermocouple with argon as inert gas and then carbonized:

Initially heating rate 2° C./min, temperature 250° C., hold time 2 hours, Ar flow rate 200 ml/min; then continuing immediately thereafter with heating rate 5° C./min, temperature 1000° C., hold time 3 hours, Ar flow rate 200 ml/min.

After cooling, 14.88 g of a black powder was obtained (carbonization yield 86%), which was freed from oversize particles by wet sieving. 14.46 g of C-coated silicon particles having a particle size of D₉₉<20 μm were obtained.

Elemental composition: Si ≥98% by weight; C 0.7% by weight; H<0.01% by weight; N 0.03% by weight; O 0.6% by weight.

Particle size distribution: Monomodal; D₁₀: 2.45 μm, D₅₀: 4.60 μm, D₉₀: 7.19 μm; (D₉₀−D₁₀)/D₅₀=1.03.

Degree of aggregation: 2.8%.

Specific surface area (BET): 2.42 m²/g.

Si imperviosity: ˜100% (impervious).

Powder conductivity: 11298.83 μS/cm.

### Comparative Example 4 (CEx. 4)

C-coated silicon particles produced using pitch as C-precursor and oxidative thermal treatment:
47.60 g of the silicon powder from example 1 (D₅₀=4.16 μm) and 0.96 g of pitch (Petromasse ZL 250M) were mechanically mixed at 80 rpm for 3 hours using a ball-mill roller bed (Siemens/Groschopp).
48.40 g of the mixture thus obtained was placed in a quartz glass boat (QCS GmbH) and thermally treated in a three-zone tube furnace (TFZ 12/65/550/E301; Carbolite GmbH) using a cascade control system including a type N sample thermocouple in an oxidative atmosphere (air):
Heating rate 2° C./min, temperature 350° C., hold time 2 hours.

After cooling to room temperature, 48.00 g of a gray powder was obtained (yield 99%). The product obtained (47.50 g) was subjected to carbonization under argon as inert gas with the following temperature program:

Heating rate 5° C./min, temperature 1000° C., hold time 3 hours, Ar flow rate 200 ml/min. After cooling to room temperature, 46.60 g of a black powder was obtained (carbonization yield 98%), which was freed from oversize particles by wet sieving.

45.80 g of C-coated silicon particles having a particle size of D₉₉<20 μm were obtained. Elemental composition: Si ≥97% by weight; C 0.9% by weight; H<0.01% by weight; N <0.01% by weight; O 0.7% by weight.

Particle size distribution: Monomodal; D₁₀: 3.51 μm, D₅₀: 5.43 μm, D₉₀: 8.57 μm; (D₉₀−D₁₀)/D₅₀=0.93.

Degree of aggregation: 1.7%.

Specific surface area (BET): 1.4 m²/g.

Si imperviosity: ˜100% (impervious).

Powder conductivity: 21006.14 μS/cm.

### Comparative Example 5 (CEx. 5)

C-coated silicon particles produced using polyacrylonitrile (PAN) as C-precursor and oxidative thermal treatment:
54.00 g of the silicon powder from example 1 (D₅₀=4.16 μm) and 10.80 g of polyacrylonitrile (PAN) were mechanically mixed at 80 rpm for 3 hours using a ball-mill roller bed (Siemens/Groschopp).
64.60 g of the mixture thus obtained was placed in a quartz glass boat (QCS GmbH) and thermally treated in a three-zone tube furnace (TFZ 12/65/550/E301; Carbolite GmbH) using a cascade control system including a type N sample thermocouple in an oxidative atmosphere (air):
Heating rate 2° C./min, temperature 250° C., hold time 2 hours.

After cooling to room temperature, 63.30 g of a gray powder was obtained (yield 98%). The product obtained (63.00 g) was subjected to carbonization under argon as inert gas with the following temperature program: Heating rate 5° C./min, temperature 1000° C., hold time 3 hours, Ar flow rate 200 ml/min.

After cooling to room temperature, 59.40 g of a black powder was obtained (carbonization yield 94%), which was freed from oversize particles by wet sieving. 58.04 g of C-coated silicon particles having a particle size of D₉₉<20 μm were obtained.

Elemental composition: Si ≥97% by weight; C 0.8% by weight; H<0.01% by weight; N 0.2% by weight; O 0.69% by weight.

Particle size distribution: Monomodal; D₁₀: 2.41 μm, D₅₀: 4.51 μm, D₉₀: 8.09 μm; (D₉₀−D₁₀)/D₅₀=1.26.

Degree of aggregation: 2.3%.

Specific surface area (BET): 1.3 m²/g.

Si imperviosity: ˜100% (impervious).

Powder conductivity: 14752.73 μS/cm.

### Example 6 (Ex. 6)

Anode comprising the C-coated silicon particles from example 2 and electrochemical testing in a lithium-ion battery:
29.71 g of polyacrylic acid (dried to constant weight at 85° C.; Sigma-Aldrich, M_{w}˜450 000 g/mol) and 756.60 g of deionized water were agitated by means of a shaker (290 l/min) for 2.5 hours until the polyacrylic acid had dissolved completely. Lithium hydroxide monohydrate (Sigma-Aldrich) was added to the solution a little at a time until the pH was 7.0 (measured using WTW pH 340i pH meter and SenTix RJD probe). The solution was then mixed by means of a shaker for another 4 hours.

7.00 g of the carbon-coated silicon particles from example 2 were then dispersed in 12.50 g of the neutralized polyacrylic acid solution and 5.10 g of deionized water by means of a dissolver at a circumferential speed of 4.5 m/s for 5 min and of 12 m/s for 30 min while cooling at 20° C. 2.50 g of graphite (Imerys, KS6L C) was added and the mixture then stirred at a circumferential speed of 12 m/s for a further 30 min. After degassing, the dispersion was applied to a copper foil having a thickness of 0.03 mm (Schlenk Metallfolien, SE-Cu58) by means of a film applicator with a gap height of 0.20 mm (Erichsen, model 360). The anode coating thus produced was then dried at 50° C. and 1 bar air pressure for 60 min. The average basis weight of the dry anode coating was 3.20 mg/cm² and the coating density 0.9 g/cm³.

The electrochemical studies were carried out in a button cell (CR2032 type, Hohsen Corp.) in a 2-electrode arrangement.

The electrode coating from example 6 was used as counterelectrode or negative electrode (Dm=15 mm); a coating based on lithium-nickel-manganese-cobalt oxide 6:2:2 having a content of 94.0% and average basis weight of 15.9 mg/cm² (obtained from SEI Corp.) was used as working electrode or positive electrode (Dm=15 mm). A glass fiber filter paper (Whatman, GD type A/E) soaked with 60 μl of electrolyte served as separator (Dm=16 mm). The electrolyte used consisted of a 1.0 molar solution of lithium hexafluorophosphate in a 1:4 (v/v) mixture of fluoroethylene carbonate and diethyl carbonate. The cell was assembled in a glovebox (<1 ppm H₂O, O₂); the water content in the dry matter of all components used was below 20 ppm.

The electrochemical testing was carried out at 20° C. The cells were charged by the cc/cv (constant current/constant voltage) method with a constant current of 5 mA/g (corresponding to C/25) in the first cycle and of 60 mA/g (corresponding to C/2) in subsequent cycles and, on reaching the voltage limit of 4.2 V, at constant voltage until the current went below 1.2 mA/g (corresponding to C/100) or 15 mA/g (corresponding to C/8). The cell was discharged by the cc (constant current) method with a constant current of 5 mA/g (corresponding to C/25) in the first cycle and of 60 mA/g (corresponding to C/2) in subsequent cycles until reaching the voltage limit of 3.0 V. The specific current chosen was based on the weight of the coating of the positive electrode.

On the basis of the formulation, the lithium-ion battery was operated by cell balancing with partial lithiation of the anode.

The results of the electrochemical testing are summarized in Table 1.

### Comparative Example 7 (CEx. 7)

Anode comprising the C-coated silicon particles from comparative example 3 and electrochemical testing in a lithium-ion battery:

A lithium-ion battery was produced and tested, as described above with example 6, with the difference that the carbon-coated silicon particles from comparative example 3 were used. The results of the electrochemical testing are summarized in Table 1.

### Comparative Example 8 (CEx. 8)

Anode comprising the C-coated silicon particles from comparative example 4 and electrochemical testing in a lithium-ion battery:

A lithium-ion battery was produced and tested, as described above with example 6, with the difference that the carbon-coated silicon particles from comparative example 4 were used. The results of the electrochemical testing are summarized in Table 1.

### Comparative Example 9 (CEx. 9)

Anode comprising the C-coated silicon particles from comparative example 5 and electrochemical testing in a lithium-ion battery:

A lithium-ion battery was produced and tested, as described above with example 6, with the difference that the carbon-coated silicon particles from comparative example 5 were used. The results of the electrochemical testing are summarized in Table 1.

TABLE 1
Results of testing for (comparative) examples 6 to 9:

| | | | | Number |
|---|---|---|---|---|
| | | | Discharge | of cycles |
| | | | capacity | with ≥80% |
| | C- | | after cycle 1 | retention of |
| (C)Ex. | precursor | Thermal treatment | [mAh/cm²] | capacity |
| 6 | PVP | oxidative atmosphere | 2.32 | 325 |
| 7 | PVP | inert atmosphere | 2.30 | 301 |
| 8 | Pitch | oxidative atmosphere | 1.95 | 275 |
| 9 | PAN | oxidative atmosphere | 2.00 | 282 |

The lithium-ion battery from example 6 according to the invention surprisingly exhibited more stable electrochemical behavior compared to the lithium-ion batteries from comparative examples 7, 8, and 9 allied with a higher discharge capacity after cycle 1.

1.-14. (canceled)

15. A method for producing nonaggregated carbon-coated particles comprising:
thermally treating a dry mixture in an oxidative atmosphere at a temperature of 200 to 400° C., the dry mixture comprising silicon particles and one or more polymeric carbon precursors containing one or more amide, lactam, imide, carbamate, urethane, sulfate, sulfate ester, sulfite, sulfite ester, sulfonic acid, sulfonic ester, thioester, phosphoric acid, phosphoric ester, phosphoric acid amide, phosphonic acid, phosphonic ester, or phosphonic acid amide functional groups; and
carbonizing the dry mixture after thermally treating in an inert atmosphere to form carbon-coated silicon particles including nonaggregated carbon-coated silicon particles.

16. The method of claim 15, wherein the one or more polymeric carbon precursors comprises one or more polyvinyl lactams, polyamides, polyimides, polyurethanes, polypeptides, proteins, or polyvinylpyrrolidone.

17. The method of claim 16, wherein the one or more polymeric carbon precursors includes a polyvinyl lactam.

18. The method of claim 15, wherein the one or more polymeric carbon precursors have molecular weights of 200 to 2,000,000 g/mol as determined by GPC.

19. The method of claim 18, wherein the one or more polymeric carbon precursors have molecular weights of 2,000 to 50,000 g/mol as determined by GPC.

20. The method of claim 15, wherein the dry mixture includes the one or more polymeric carbon precursors at 1 to 80% by weight based on a total weight of the dry mixture.

21. The method of claim 15, wherein the oxidative atmosphere comprises one or more oxidative gases including oxygen, carbon dioxide, nitrogen oxides, sulfur dioxides, ozone, peroxides, and water vapor.

22. The method of claim 15, wherein the oxidative atmosphere comprises air.

23. The method of claim 15, wherein the carbon-coated silicon particles have a volume-weighted particle size distribution having a diameter percentile d₅₀ of 1 to less than 15 μm.

24. The method of claim 15, wherein carbonizing includes temperatures of above 400° C. and up to 1400° C.

25. The method of claim 15, wherein the carbon-coated silicon particles have a degree of aggregation of ≤40% as determined by sieve analysis.

26. The method of claim 15, wherein the carbon-coated silicon particles have a degree of aggregation of ≤20% as determined by sieve analysis.

27. The method of claim 15, wherein the carbon-coated silicon particles include a carbon coating having an average thickness of 1 to 100 nm.

28. The method of claim 15, wherein the carbon-coated silicon particles and silicon particles have a difference between a volume-weighted particle size distribution d₅₀ of the carbon-coated silicon particles and a volume-weighted particle size distribution d₅₀ of the silicon particles of ≤5 μm.

29. The method of claim 15, wherein the carbon-coated silicon particles have an average volume-weighted particle diameter d₅₀ of 1 to 15 μm determined by static laser scattering using a Mie model and with ethanol as a dispersion medium, and containing ≤10% by weight of carbon and ≥90% by weight of silicon, each based on a total weight of the carbon-coated silicon particles.

30. The method of claim 15, further comprising forming an anode comprising the carbon-coated silicon particles.

31. The method of claim 15, wherein the carbon-coated silicon particles include carbon at 0.1 to 8% by weight and silicon at 92 to 99.9% by weight.

32. The method of claim 31, wherein the carbon-coated silicon particles include carbon at 0.5 to 4% by weight and silicon at 96 to 99.5% by weight.

33. The method of claim 15, wherein the one or more polymeric carbon precursors includes polyvinylpyrrolidone.

34. The method of claim 15, wherein thermal treating is at a temperature that is 50 to 300° C. below a decomposition temperature of the one or more polymeric carbon precursors.
